(19) United States
(12) Patent Application Publication
(10) Pub. No.: US 2022/0386832 A1
(43) Pub. Date: Dec. 8, 2022

(54) Cleaning Wand Device

(71) Applicant: April Hall, Owatonna, MN (US)

(72) Inventor: April Hall, Owatonna, MN (US)

(21) Appl. No.: 17/682,288

(22) Filed: Feb. 28, 2022

Related U.S. Application Data
(60) Provisional application No. 63/195,906, filed on Jun. 2, 2021.

(51) Int. Cl. A47L 1/15

(52) U.S. Cl. CPC A47L 1/15

(57) ABSTRACT

The present invention relates generally to the field of cleaning devices. More specifically, the present invention relates to a cleaning wand device that is primarily comprised of an inner shaft, an outer shaft, and a head. The device is primarily comprised of an inner shaft, an outer shaft, and a head. The device has a rotating head that can be positioned to make contact and clean surfaces of any shape and size. The device may also be comprised of two shafts or may be of a fixed length to allow the device to extend to clean hard-to-reach areas. The head of the device can rotate to different angles and retain any cloth or wipe such that any surface that can be cleaned by the device in an efficient manner.

### CROSS-REFERENCE TO RELATED APPLICATION

The present application claims priority to, and the benefit of, U.S. Provisional Application No. 63/195,906, which was filed on Jun. 2, 2021, and is incorporated herein by reference in its entirety.

### FIELD OF THE INVENTION

The present invention relates generally to the field of cleaning devices. More specifically, the present invention relates to a cleaning wand device that is primarily comprised of an inner shaft, an outer shaft, and a head. The device is primarily comprised of an inner shaft, an outer shaft, and a head. The device has a rotating head that can be positioned to make contact and clean surfaces of any shape and size. The device may also be comprised of two shafts or may be of a fixed length to allow the device to extend to clean hard-to-reach areas. The head of the device can rotate to different angles and retain any cloth or wipe such that any surface that can be cleaned by the device in an efficient manner. Accordingly, the present disclosure makes specific reference thereto. Nonetheless, it is to be appreciated that aspects of the present invention are also equally applicable to other like applications, devices and methods of manufacture.

### BACKGROUND

Vehicle windshields tend to get dirty quickly, which can interfere with the driver's ability to see the road. Keeping windshields clean can be a labor-intensive task as it often involves straining and reaching to get to every inch and corner of the windshield. Both the outside and inside of the windshield may need cleaned often, which may involve switching positions and moving to both the driver and passenger sides of the vehicle to clean the entire windshield. On taller vehicles, the windshield may be difficult to reach from the ground such that a ladder may also be required to reach every portion of the windshield. Similarly, large picture windows and other glass surfaces may not be easily reached with common cleaning equipment, potentially leaving them dirty or with streaks.

Therefore, there exists a long-felt need in the art for an improved cleaning wand device. There also exists a long-felt need in the art for a cleaning wand device that can extend, making hard-to-reach places easy to clean. Further, there exists a long-felt need in the art for a cleaning wand device that allows for the attachment of any type of cleaning cloth or wipe such that differing surfaces requiring differing chemicals or textures may be cleaned. In addition, there exists a long-felt need in the art for a cleaning wand device that can rotate to different angles such that the device can clean hard-to-reach places or surfaces of any shape.

The subject matter disclosed and claimed herein, in one embodiment thereof, comprises a cleaning wand device. The device is primarily comprised of an inner shaft, an outer shaft, and a head. The device has a rotating head that can be positioned to make contact and clean surfaces of any shape and size. The device may also be comprised of two shafts that allow the device to extend to clean hard-to-reach areas. The head of the device can rotate to different angles and retain any cloth or wipe such that any surface that can be cleaned by the device in an efficient manner.

In this manner, the cleaning wand device of the present invention accomplishes all the forgoing objectives and provides an improved means for cleaning hard-to-reach places. Further, the device is compatible with any cloth or wipe such that differing cloths or wipes may be used to clean surfaces that require specific cleaning chemicals or surfaces to do not cause damage. In addition, the device can extend in length and rotate to different angles to clean hard-to-reach areas and surfaces of any shape.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a cleaning wand device. The device is primarily comprised of an inner shaft, an outer shaft, and a head. In differing embodiments, the device may be made of a plurality of materials such as, but not limited to rigid plastic or metal. In addition, any surface of the device may be comprised of a plurality of indicia such as patterns, logos, emblems, images, symbols, designs, letters, words, characters, animals, advertisements, brands, etc.

The device is comprised of two generally cylindrical shafts, an inner shaft that fits in the hollow space of an outer shaft. However, one embodiment of the device may be of a fixed length and has only an outer shaft. Attached to one end of the inner shaft is a handle which a user may use to hold the device. The handle is further comprised of a grip and continuous opening and is preferably circular but may be of any shape. The inner shaft may move in position relative to the outer shaft such that the length of the device can increase or decrease. The opposite end of the inner shaft is attached to a spring, wherein an internal hook is attached to the spring. The hook and be attached or released from the spring via pressing an external lever to allow the length of the device to increase or decrease.

A head is attached to the second end of the outer shaft via at least one hinge and a bracket. The bracket attaches to the top surface of the head, and the hinge attaches the second end of the outer shaft to the bracket. The hinge allows the head of the device to rotate to various angles and positions, allowing the device to move with the shape of the surface on which it is being used to clean. Further, the top surface of the device is comprised of at least one opening, which is further comprised of a plurality of flaps. To clean surfaces, a wipe may be placed on the bottom of the head and the corners of the wipe can be folded around the head and pressed into the openings on the top surface of the head. The flaps hold the wipe in place as the head is moved across surfaces. The wipe may be disposable or reusable in differing embodiments, such that a new wipe may be placed on the head if the original wipe becomes dirty or inefficient.

Accordingly, the cleaning wand device of the present invention is particularly advantageous as it allows a user to clean hard-to-reach places. Further, the device can extend and rotate to various lengths and positions, allowing the device to contour to the surface of the area which it is cleaning. In addition, the device is compatible with any cloth or wipe such that the device can clean different surfaces requiring differing chemicals or cleaning methods. In this manner, the cleaning wand device overcomes the limitations of existing cleaning devices known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of a cleaning wand device of the present invention in accordance with the disclosed architecture;

FIG. 2 illustrates multiple perspective views of one potential embodiment of a cleaning wand device of the present invention in extended and un-extended positions in accordance with the disclosed architecture;

FIG. 3 illustrates an enhanced perspective view of one potential embodiment of a cleaning wand device of the present invention in accordance with the disclosed architecture; and

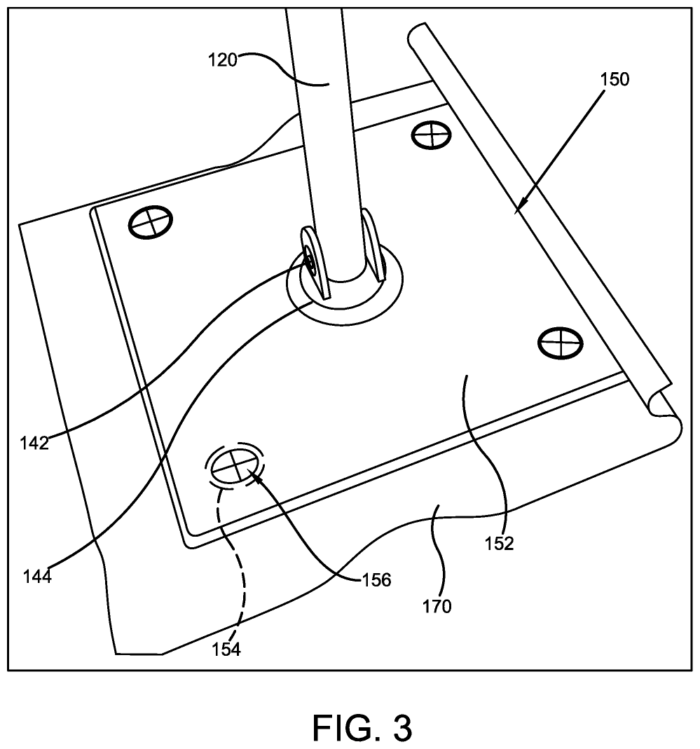

FIG. 4 illustrates an enhanced perspective view of one potential embodiment of a cleaning wand device of the present invention in accordance with the disclosed architecture.

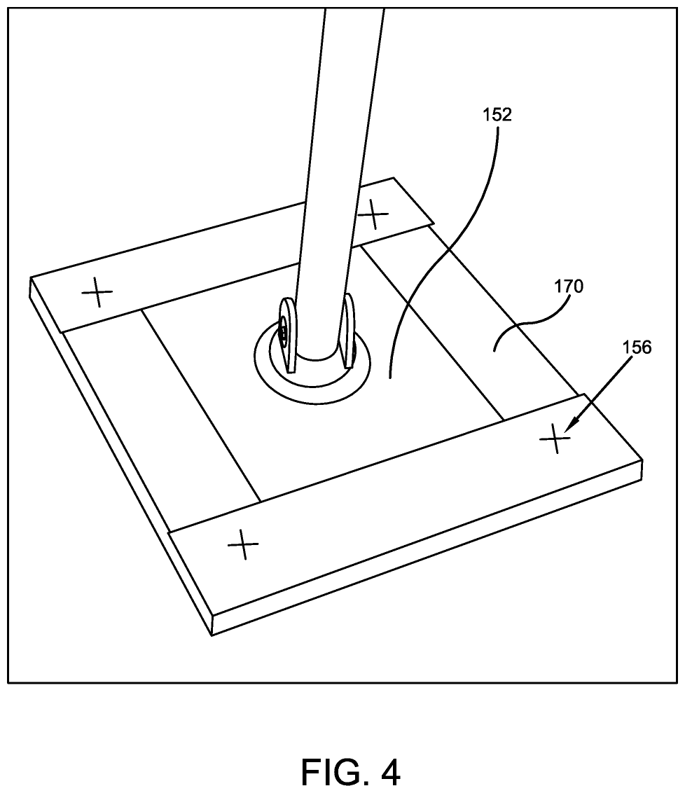

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long-felt need in the art for an improved cleaning wand device. There also exists a long-felt need in the art for a cleaning wand device that can extend, making hard-to-reach places easy to clean. Further, there exists a long-felt need in the art for a cleaning wand device that allows for the attachment of any type of cleaning cloth or wipe such that differing surfaces requiring differing chemicals or textures may be cleaned. In addition, there exists a long-felt need in the art for a cleaning wand device that can rotate to different angles such that the device can clean hard-to-reach places or surfaces of any shape.

The present invention, in one exemplary embodiment, is comprised of a cleaning wand device capable of extending and rotating such that it can clean hard-to-reach areas and surfaces of any shape. The device is primarily comprised of an inner shaft, an outer shaft, and a head. In differing embodiments, the device may be made of a plurality of materials that may be commonly used for making cleaning products but is preferably made of a flexible or semi-flexible plastic material. In addition, any surface of the device may be comprised of a plurality of indicia such as patterns, logos, emblems, images, symbols, designs, letters, words, characters, animals, advertisements, brands, etc.

Further, the device may be comprised of two shafts, an inner shaft and an outer shaft, which are both generally cylindrical in shape. However, the device may also only have an outer shaft and thus be of a fixed length. The outer shaft is hollow such that the inner shaft may insert into the outer shaft. Fixedly or removably attached to one end of the inner shaft is a handle, further comprised of a continuous opening and a grip. The handle may be of any shape but is preferably circular. The continuous opening allows a user to wrap their fingers around the handle and retain the device. Preferably, the user places their hand on the grip of the handle to better retain the device and hold it more comfortably, but any portion of the handle may be held to better fit the preferences of the user. In one potential embodiment, the inner shaft is connected to a spring at its other end. The spring may sit in the hollow space of the outer shaft such that the spring is in a neutral position when the device is halfway between its maximum and minimum lengths. As the inner shaft is pulled outward from the outer shaft increasing the length of the device, the spring increases in length and experiences tension. As the inner shaft is pushed into the outer shaft decreasing the length of the device, the spring decreases in length and experiences compression. The opposite end of the inner shaft is attached to a spring, wherein an internal hook is attached to the spring. The hook and be attached or released from the spring via pressing an external lever to allow the length of the device to increase or decrease.

A second end of the outer shaft is fixedly or removably attached to a head via an at least one hinge and a bracket. The bracket may be fixedly attached to a top surface of the head, and the hinge attaches to the bracket. The hinge allows the head of the device to rotate to various angles and positions such that it can clean hard-to-reach areas and surfaces of any shape. Further, the top surface of the head is comprised of at least one opening which is further comprised of a plurality of flaps. The flaps may be made of a flexible or semi-flexible rubber material such that they are pliable. At least one cloth or wipe may be provided such that can attach to the head of the device. The wipe folds around the head of the device and may be pressed into the openings on the top surface of the head. The flaps hold the wipe onto the head of the device so that the head may be pressed against objects to clean the surfaces of the objects. When the user is finished with the wipe, the wipe may be removed by simply pulling the wipe out of the flaps. A new wipe may be placed on the head if needed.

Accordingly, the cleaning wand device of the present invention is particularly advantageous as it allows a user to clean hard-to-reach places. Further, the device can be used to clean any surface or material as it is compatible with any cloth or wipe known in the art. In addition, the device can extend and compress to various lengths as well as pivot to various different angles such that the device can reach and contour to the surface or area which it is cleaning. Therefore, the device eliminates unnecessary reaching and twisting of the body required by the limitations of existing cleaning devices known in the art.

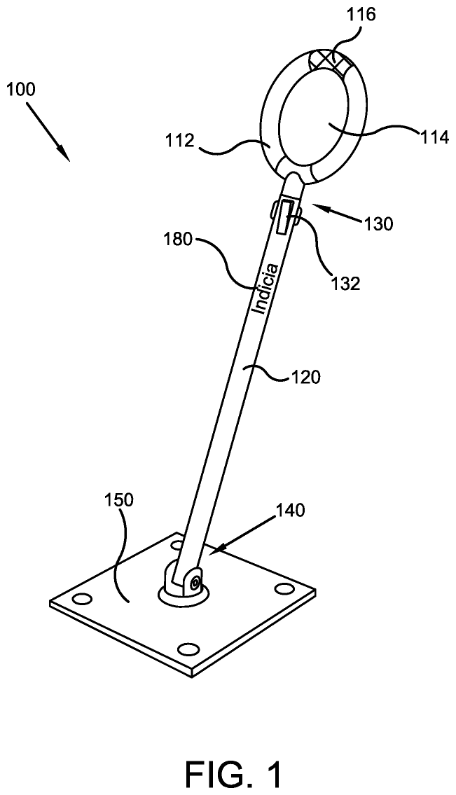

Referring initially to the drawings, FIG. 1 illustrates a perspective view of one potential embodiment of a cleaning wand device 100 of the present invention in accordance with the disclosed architecture. The device 100 is primarily comprised of an inner shaft 110, an outer shaft 120, and a head 150. In differing embodiments, the device 100 may be made of a plurality of materials such as, but not limited to wood or metal. However, the device 100 is preferably made of a rigid or semi-rigid plastic such as but not limited to: acrylic, polycarbonate, polyethylene, thermoplastic, acrylonitrile butadiene styrene, low density polyethylene, medium density polyethylene, high density polyethylene, polyethylene terephthalate, polyvinyl chloride, polystyrene, polylactic acid, acetal, nylon, fiberglass, etc. In addition, the device 100 may be transparent, semi-transparent, or opaque in differing embodiments. Furthermore, any surface of the device 100 may be comprised of any number of indicia 180 in the form of patterns, logos, emblems, images, symbols, designs, letters, words, characters, animals, advertisements, brands, etc.

In the preferred embodiment of the device 100 shown in FIG. 1, the device 100 is comprised of two shafts, an inner shaft 110 and an outer shaft 120, wherein both shafts 110, 120 are generally cylindrical in shape. The outer shaft 120 is hollow such that the inner shaft 110 may insert into the outer shaft 120. However, the inner shaft 110 may be either solid or hollow in differing embodiments. However, in a non-adjustable embodiment of the device 100, the device 100 may only have an outer shaft 120. A handle 112 may be fixedly or removably attached to one end of the inner shaft 110. The handle 112 is further comprised of a continuous opening 114 and a grip 116. The handle 112 may resemble any shape but is preferably generally circular in shape to aid in hand positioning for the user. The grip 116 may simply be a material that aids in retention of the device 100 or may be comprised of protrusions or grooves that contour to the human hand. The continuous opening 114 of the handle 112 allows a user to wrap their fingers around the handle 112 in any orientation desired by the user. The grip 116 of the handle 112 may be only a small portion of the handle 112 or the entire surface of the handle 112 may be comprised of the grip 116. The grip 116 may be textured to contour to the human hand, or it may simply be a differing material that aids in gripping the handle 112, such as rubber.

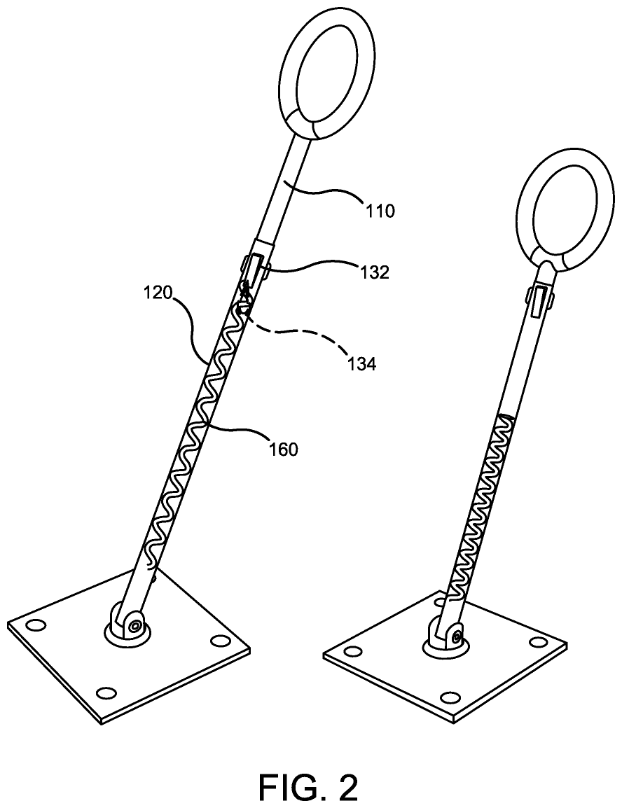

FIG. 2 illustrates multiple perspective views of one potential embodiment of a cleaning wand device 100 of the present invention in extended and un-extended positions in accordance with the disclosed architecture. In one potential embodiment, the inner shaft 110 of the device 100 is connected to a spring 160 at its end opposite the handle 112. The spring 160 sits in the hollow space of the outer shaft 120 such that the spring 160 is in a neutral position when the inner shaft 110 is inserted halfway into the outer shaft 120. In one embodiment, the device 100 is of a fixed length. However, in another embodiment the device 100 is adjustable in length. To adjust the length of the device 100, the inner shaft 110 may be pushed into or pulled out of the outer shaft 120. By pushing the inner shaft 110 into the outer shaft 120, the length of the device 100 decreases as the spring 160 compresses. By pulling the inner shaft 110 out of the outer shaft 120, the length of the device 100 increases as the length of the spring 160 increases. In both cases, the spring 160 will attempt to push or pull the inner shaft 110 back to its neutral position. The spring 160 is further engaged by an inner hook 134. At least one lever 132 is further located on the outer shaft 120, wherein pressing the lever 132 releases the inner hook 134 from the spring 160 and allows the device 100 to expand in length. When the spring 160 remains engaged by the inner hook 134, the device 100 remains at a fixed length. In one embodiment of the device 100, the lever 132 may be a revolver-style lever that can be cocked backwards to release the inner hook 134 from the spring 160.

A second end 140 of the outer shaft 120 may be fixedly or removably attached to a head 150 via an at least one hinge 142 and bracket 144. The bracket 144 may be fixedly attached to a top surface 152 of the head 150. The hinge 142 attached to the second end 140 of the outer shaft 120 is attached to the bracket 144 and may be tightened by a fastener or other method of attachment. The hinge 142 allows the head 150 of the device 100 to rotate to various angles and positions such that it can clean areas that may be difficult to reach. Further, the top surface 152 of the head 150 is comprised of at least one opening 154 which is further comprised of a plurality of flaps 156. Preferably, each opening 154 is comprised of four flaps 156, each with generally triangular points that meet in the middle of the opening 154. At least one cloth or wipe 170 may be provided such that it can attach to the head 150 of the device 100. The wipe 170 is placed on the bottom of the head 150 and folds around the head 150 such that it can be pressed into the openings 154 on the top surface 152 of the head 150 and retained. The flaps 156 may be made of a flexible or semi-flexible rubber material such that they are pliable, securing the wipe 170 in place as the head 150 of the device is pressed against objects to clean the surfaces of the objects. The wipe 170 may have antibacterial and/or antimicrobial properties and may also be moistened or dry to better clean surfaces such as but not limited to, a windshield. Upon completion of cleaning, the user may dispose of the wipe 170 by removing it from the flaps 156 in the openings 154 of the head 150. A new wipe 170 may then be applied to the head 150 if more cleaning is needed.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “cleaning wand device” and “device” are interchangeable and refer to the cleaning wand device 100 of the present invention.

Notwithstanding the forgoing, the cleaning wand device 100 of the present invention and its various components can be of any suitable size and configuration as is known in the art without affecting the overall concept of the invention, provided that they accomplish the above-stated objectives. One of ordinary skill in the art will appreciate that the size, configuration and material of the cleaning wand device 100 as shown in the FIGS. are for illustrative purposes only, and that many other sizes and shapes of the cleaning wand device 100 are well within the scope of the present disclosure. Although the dimensions of the cleaning wand device 100 are important design parameters for user convenience, the cleaning wand device 100 may be of any size, shape and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A cleaning wand device comprising:
an outer shaft;
an inner shaft positioned at least partially within the outer shaft and repositionable relative to the outer shaft;
a handle;
a head; and
a wipe.

2. The cleaning wand device of claim 1, wherein the outer shaft and the inner shaft are cylindrical in shape.

3. The cleaning wand device of claim 2, wherein the outer shaft and the inner shaft are hollow.

4. The cleaning wand device of claim 1, wherein the head receives the wipe.

5. The cleaning wand device of claim 4, wherein the wipe is a placed on the head and folds around a top surface of the head.

6. The cleaning wand device of claim 5, wherein the wipe is retained on the head via a continuous opening with a plurality of flaps located on the top surface.

7. A cleaning wand device comprising:
an outer shaft;
an inner shaft;
a spring positioned within the outer shaft and attached to the inner shaft;
a handle;
a lever;
an internal hook;
a bracket;
a head connected to the outer shaft via a hinge, wherein a top surface of the head is comprised of a continuous opening and a plurality of flaps; and
a wipe that is retained on the head via the plurality of flaps.

8. The cleaning wand device of claim 7, wherein the hinge allows the head to rotate about the other shaft.

9. The cleaning wand device of claim 7, wherein the outer shaft and the inner shaft are telescopic.

10. The cleaning wand device of claim 9, wherein the spring is biased when the inner shaft extends outwardly from the outer shaft.

11. The cleaning wand device of claim 9, wherein the lever engages the inner hook.

12. The cleaning wand device of claim 7, wherein the outer shaft and the inner shaft are cylindrical in shape.

13. The cleaning wand device of claim 12, wherein the outer shaft and the inner shaft are hollow.

14. The cleaning wand device of claim 7, wherein the wipe is folded around the head.

15. A cleaning wand device comprising:
a shaft;
a handle;
a bracket;
a head connected to the shaft via a hinge, wherein a top surface of the head is comprised of a continuous opening and a plurality of flaps; and
a wipe that is retained on the head via the plurality of flaps.

16. The cleaning wand device of claim 15, wherein the hinge allows the head to rotate relative to the shaft.

17. The cleaning wand device of claim 15 further comprising a second shaft that is housed within, and is telescopic relative to, the shaft.

18. The cleaning wand device of claim 15, wherein the shaft is cylindrical.

19. The cleaning wand device of claim 18, wherein the shaft is hollow.

20. The cleaning wand device of claim 15, wherein the wipe is folded around the head.
